(19) United States
(12) Patent Application Publication
(10) Pub. No.: US 2015/0291705 A1
(43) Pub. Date: Oct. 15, 2015

(54) GLYCOL CHITOSAN DERIVATIVE HAVING HYDROPHOBIC SUBSTITUENT, METHOD FOR PREPARING SAME AND USE OF SAME

(71) Applicants: WINNOVA CO., LTD., Pyungtaek-si, Gyeonggi-do (KR); THE INDUSTRY & ACADEMIC COOPERATION IN CHUNGNAM NATIONAL UNIVERSITY, Yuseong-gu, Daejeon (KR)

(72) Inventors: Kang Moo Huh, Daejeon (KR); Zheng Zheng Li, Daejeon (KR); Bosun Kwon, Seoul (KR)

(73) Assignees: WINNOVA CO., LTD., Pyungtaek-si, Gyeonggi-do (KR); THE INDUSTRY & ACADEMIC COOPERATION IN CHUNGNAM NATIONAL UNIVERSITY, Yuseong-gu, Daejeon (KR)

(21) Appl. No.: 14/438,951

(22) PCT Filed: Jun. 25, 2013
(86) PCT No.: PCT/KR2013/005586

§ 371 Date: Apr. 28, 2015

(30) Foreign Application Priority Data
Oct. 31, 2012 (KR) 10-2012-0121812

(51) Int. Cl. C08B 37/08

(52) U.S. Cl. CPC C08B 37/003

(57) ABSTRACT

The present invention is directed to a glycol chitosan derivative having a hydrophobic substituent, to a method for preparing the glycol chitosan derivative, and to a use of the glycol chitosan derivative. In particular, the glycol chitosan derivative has a structure where an amine group at the 2-position is partially substituted with an acetyl group and a hydrophobic group R and is utilized in medical, bio, electric and other fields, by virtue of its thermo-sensitive characteristics of causing sol-gel transition at a predetermined temperature.

### CROSS-REFERENCE TO RELATED APPLICATION

This application claims priority to and the benefit of Korean Patent Application No. 10-2012-0121812, filed on Oct. 31, 2012, with the Korean Intellectual Property Office and PCT Patent Application No. PCT/KR2013/005586, filed on Jun. 25, 2013, the disclosure of which is incorporated herein in its entirety by reference.

### BACKGROUND

1. Field

The present disclosure of invention relates to a glycol chitosan derivative having a hydrophobic substituent that has thermo-reversible sol-gel transition properties, to a method for preparing the glycol chitosan derivative, and to a use of the glycol chitosan derivative.

2. Description of the Related Art

A phase-transition polymer refers to a polymer that is sensitive to external stimuli to show continuous or discontinuous changes in physical properties, such as a degree of hydration. In this case, the external stimuli may be chemical or biochemical stimuli, such as pH, ion, and metabolite, and physical stimuli, such as temperature, light, and solvent.

Among the phase-transition polymers, a thermo-sensitive polymer may play an important role in a medicament delivery system by virtue of its characteristics to sensitively respond to temperature changes. Such a thermo-sensitive polymer is first introduced by Heskin and Geillet [M. Heskins and J. E Guillet, J. Macromol. Sci. Chem., A2, 1441 (1968)], and examples thereof may include poly(N-isopropylacrylamide)(poly(NIPAAm). The thermo-sensitive polymers have been extensively studied for their use in a wide range of applications.

As an example, the thermo-sensitive polymer may sensitively respond to temperature changes, which may cause phase transition, and thus drug release can be controlled according to temperature changes. By virtue of such characteristics, the thermo-sensitive polymer may be utilized in intelligent medicament delivery system and sensors. Further, the thermo-sensitive polymer may be injected into the body as an aqueous solution and then may form a gel at a desired portion of the body, without requiring surgical procedures after use. By virtue of such characteristics, the thermo-sensitive polymer may be utilized in pharmaceutical and biotechnology fields, such as sustained-release medicament delivery system and tissue growth implant.

Korean Patent Publication No. 2011-0021570 discloses a method for measuring temperature of a micro-channel inside a microfluidic chip, which utilizes a thermo-sensitive fluorescence conjugated polymer as a temperature sensor. Polydiacetylene is used as the thermo-sensitive polymer.

Korean patent No. 10-0474528 discloses, for a medical purpose, a polymer grafted with polysaccharides and a thermo-sensitive polymer selected from the group consisting of acrylamide polymer, a copolymer of acrylamide monomer-vinyl monomer, or a copolymer of acrylamide monomer-acrylic monomer.

Further, Korean patent No. 10-0668046 discloses a biocompatible and thermo-sensitive polyethylene glycol/biodegradable polyester block copolymer including a hydrophilic portion incorporating a polyethylene glycol and a caprolactone (CL) segment as essential components, including a paradioxanone (PDO) segment, a trimethylene carbonate (TMC) segment, or a biodegradable polyester-based hydrophobic portion that includes both the PDO and TMC segments, and having a molecular weight of about 2,000 to 7,000 g/mole.

In addition, applications in the environmental field are also studied. Korean Patent No. 10-1109147 discloses a thermo-sensitive three-dimensional copolymer including a photocatalyst that may efficiently decompose, eliminate and also may collect and recycle a small amount of toxic chemicals contained in wastewater. P(NIPAm)(Poly(N-isopropyl acrylamide) is suggested as the thermo-sensitive copolymer.

### PRIOR ART DOCUMENT

### Patent Document

(Patent Document 1) Korean Patent Publication No. 2011-0021570
(Patent Document 2) Korean Patent Registration No. 10-0474528
(Patent Document 3) Korean Patent Registration No. 10-0668046
(Patent Document 4) Korea Patent Registration No. 10-1109147

### Non-Patent Document

(Non-Patent Document 1) M. Heskins and J. E Guillet, J. Macromol. Sci. Chem., A2, 1441 (1968)

It is to be understood that this background of the technology section is intended to provide useful background for understanding the technology and as such disclosed herein, the technology background section may include ideas, concepts or recognitions that were not part of what is known or appreciated by those skilled in the pertinent art prior to a corresponding effective filing date of subject matter disclosed herein.

### SUMMARY

The present disclosure of invention is directed to a glycol chitosan derivative having a hydrophobic substituent controlled in types and degrees of substitution of the substituent to have thermo-reversible sol-gel transition properties, and to a method for preparing the glycol chitosan derivative.

Further, the present disclosure of invention is directed to a use of the glycol chitosan derivative having a hydrophobic substituent having thermo-sensitive properties.

According to an embodiment of the present invention, a glycol chitosan derivative having a hydrophobic substituent may be represented by the following Chemical Formula 1. An amine group at the 2-position may be partially substituted with an acetyl group and a hydrophobic group R, and the glycol chitosan may have thermo-reversible sol-gel transition properties,

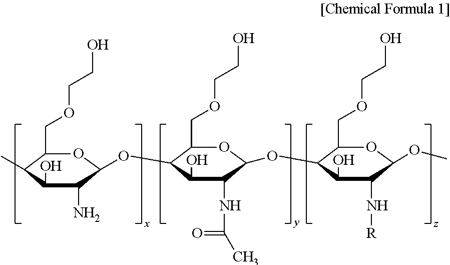

wherein R (hydrophobic group) may be one of a cyano group, a nitro group, a C1-C18 alkyl group, a C1-C18 haloalkyl group, a C3-C8 cycloalkyl group, a C1-C20 acyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,

desirably, the acyl group may be represented by —C(═O)—R₁ and R₁ may be one of a C1-C18 alkyl group, a C1-C18 haloalkyl group, a C3-C8 cycloalkyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group, and

x, y, and z each may be an integer selected from 10 to 10000 and mole % thereof may be 0.1≦x≦0.6, 0.1≦y≦0.2, and 0.2≦z≦0.8, respectively.

According to an embodiment of the present invention, a method for preparing a glycol chitosan derivative having a hydrophobic substituent represented by Chemical Formula 1 may include reacting an N-acetylated glycol chitosan derivative represented by Chemical Formula 6 with an RX derivative represented by Chemical Formula 7,

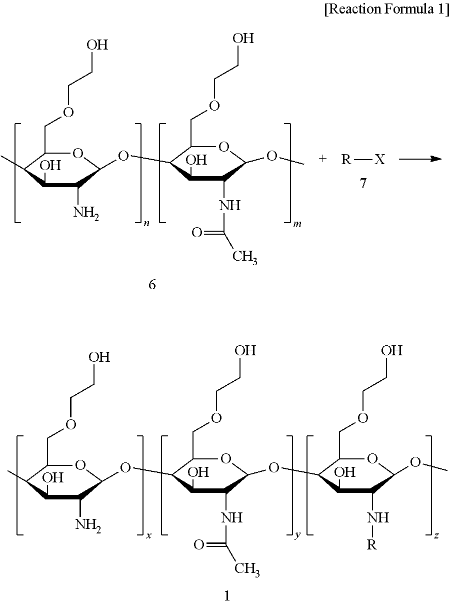

wherein R, x, y, and z are identical to those of Chemical Formula 1,

n and m each are an integer selected from 10 to 10000 and mole % thereof are 0.8≦n≦0.975 and 0.025≦m≦0.2, and

X is a leaving group.

Further, according to an embodiment of the present invention, a use of a medicament carrier including a glycol chitosan derivative having a hydrophobic substituent represented by Chemical Formula 1 or including a pharmaceutically acceptable salt thereof may include clathrating and then releasing medicament.

Further, according to an embodiment of the present invention, a use of a cell carrier including a glycol chitosan derivative having a hydrophobic substituent represented by Chemical Formula 1 or including a pharmaceutically acceptable salt thereof may include supporting or delivering cells.

Further, according to an embodiment of the present invention, a use of a thermo-sensitive sensor including a glycol chitosan derivative having a hydrophobic substituent represented by Chemical Formula 1 may be provided.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention be more clearly understood from the following detailed description taken in conjunction with the accompanying drawings, in which:

FIG. 1 is a ¹H-NMR spectrum of propionyl glycol chitosans prepared according to Exemplary Embodiments 1 to 5;

FIG. 2 is a ¹H-NMR spectrum of butyryl glycol chitosans prepared according to Exemplary Embodiments 6 to 10;

FIG. 3 is a ¹H-NMR spectrum of pentanoyl glycol chitosans prepared according to Exemplary Embodiments 11 to 14;

FIG. 4 is a ¹H-NMR spectrum of hexanoyl glycol chitosans prepared according to Exemplary Embodiments 15 to 18;

FIG. 5 is a FT-IR spectrum of propionyl glycol chitosans prepared according to Exemplary Embodiments 1 to 4;

FIG. 6 is a FT-IR spectrum of butyryl glycol chitosans prepared according to Exemplary Embodiments 6 to 9;

FIG. 7 is a FT-IR spectrum of pentanoyl glycol chitosans prepared according to Exemplary Embodiments 11 to 14;

FIG. 8 is a FT-IR spectrum of hexanoyl glycol chitosans prepared according to Exemplary Embodiments 15 to 18;

FIG. 9(a) is a picture illustrating sol-gel behavior of the propionyl glycol chitosan prepared according to Exemplary Embodiment 3, and FIG. 9(b) is a picture illustrating sol-gel behavior of thehexanoyl glycol chitosan prepared according to Exemplary Embodiment 17;

FIG. 10 is a graph showing a sol-gel critical temperature of —NH-alkylacyl glycol chitosans prepared according to Exemplary Embodiments 3, 4, 8, 9, 13, 16, and 17;

FIG. 11 is a ¹H-NMR spectrum of the alkylacyl glycol chitosans according to temperature, where a spectrum (a) illustrates a —NH-alkylacyl glycol chitosan prepared according to Exemplary Embodiment 4; a spectrum (b) according to Exemplary Embodiment 9; a spectrum (c) according to Exemplary Embodiment 13; and a spectrum (d) according to Exemplary Embodiment 17; and

FIG. 12 is a graph showing a critical degree of substitution of the alkylacyl glycol chitosans according to types of functional groups.

### DETAILED DESCRIPTION

Hereinafter the present invention will be described in more detail.

Embodiments of the present invention are direct to a derivative having thermo-sensitive properties capable of causing sol-gel transition reversible at a predetermined temperature, to a method for preparing the derivative, and to a use of utilizing the derivative in a wide range of applications in medical, bio, and electric fields.

In more detail, a glycol chitosan derivative according to the present invention that is substituted with a glycol group at the 5-position has a structure where an amine group at the 2-position is partially substituted with an acetyl group and a hydrophobic group R, as illustrated in the following Chemical Formula 1,

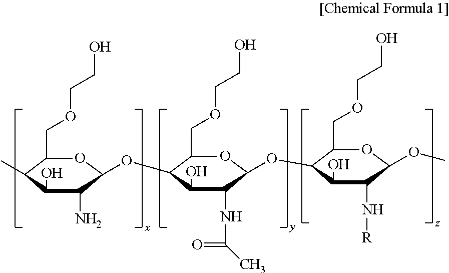

wherein R (hydrophobic group) may be one of a cyano group, a nitro group, a C1-C18 alkyl group, a C1-C18 haloalkyl group, a C3-C8 cycloalkyl group, a C1-C20 acyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,

the acyl group may be represented by —C(═O)—R₁ and R₁ may be one of a C1-C18 alkyl group, a C1-C18 haloalkyl group, a C3-C8 cycloalkyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group, and

x, y, and z each are an integer selected from 10 to 10000 and mole % thereof are 0.1≦x≦0.6, 0.1≦y≦0.2, and 0.2≦z≦0.8, respectively.

In this case, the C1-C18 alkyl group may be one of methyl, ethyl, propyl, isopropyl, butyl, pentyl, hexyl, heptyl, octyl, decyl, and lauryl groups; the C1-C18 haloalkyl group may be an alkyl group where a hydrogen atom of the alkyl group is substituted with chlorine, fluorine, or iodine; the C3-C8 cycloalkyl group may be one of cyclopropyl, cyclobutyl, cyclopentyl, cyclohexyl, and cycloheptyl groups, the C1-C8 alkoxy group may be one of methoxy, ethoxy, propoxy, isopropoxy, butoxy, hexyloxy, and octyloxy groups; the C1-C8 alkylcarbonyl group may be one of formyl, acetyl, propionyl, and butyryl groups; the C1-C8 alkoxycarbonyl group may be one of methoxycarbonyl, ethoxycarbonyl, propoxycarbonyl, butoxycarbonyl, hexyloxycarbonyl, and octyloxycarbonyl; the C6-C14 aryl group may be one of phenyl and naphthyl groups; the C6-C10 arylalkyl group may be one of benzyl and phenethyl groups; the C6-C10 arylcarbonyl group may be one of benzoyl and toluil groups; and the C2-C20 acyl group may be represented by —C(═O)—R₁, where R1 is a C1-C18 alkyl group.

The glycol chitosan derivative having a hydrophobic substituent represented by Chemical Formula 1, desirably, may include an alkylacyl group as R, more desirably a C1-C18 alkylacyl group, and most desirably a C2-C18 alkyl group, where 0.25≦x≦0.6, 0.025≦y≦0.2, and 0.2≦z≦0.7.

The glycol chitosan derivative having a hydrophobic substituent represented by Chemical Formula 1, more desirably, may be a compound, represented by the following Chemical Formula 2, where R₁ is substituted with an alkylacyl group (—C(═O)R₁) of a C1-C18 alkyl group,

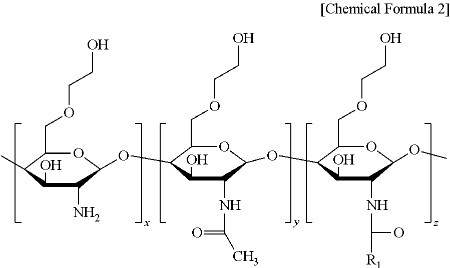

wherein x, y, z and R₁ are identical to those of Chemical Formula 1.

The glycol chitosan derivative according to the present invention, more desirably, may be one of an N-propionyl glycol chitosan represented by the following Chemical Formula 3, an N-butyryl glycol chitosan represented by the following Chemical Formula 4, an N-pentanoyl glycol chitosan represented by the following Chemical Formula 5, and an N-hexanoyl glycol chitosan represented by the following Chemical Formula 6.

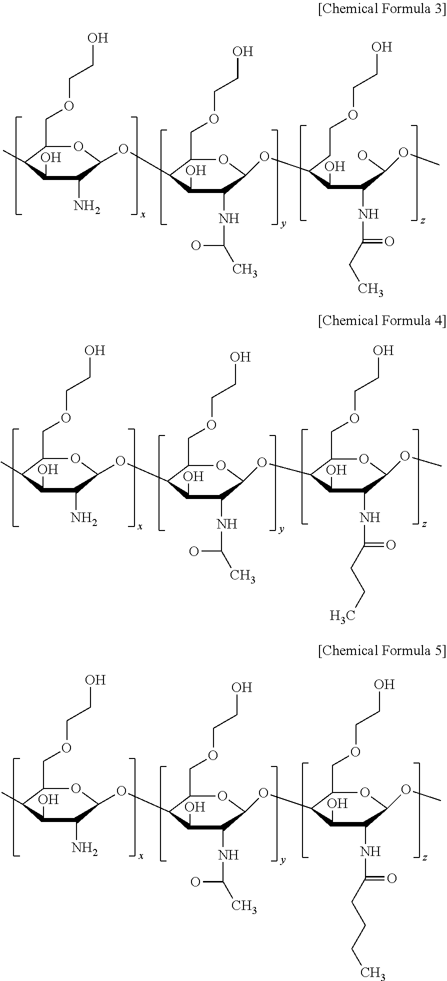

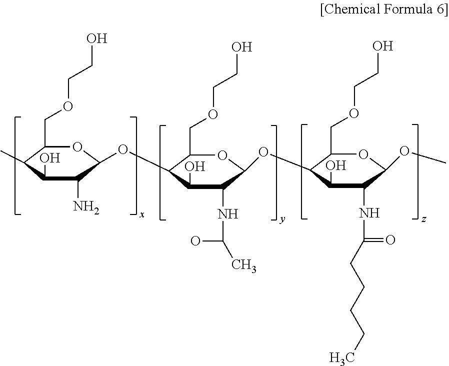

The glycol chitosan derivative having a hydrophobic substituent according to the present invention, as shown in Chemical Formula 1, may include, for example, a glycol group, an amine group, an acetyl group and a hydrophobic group as a substituent. The glycol group and the amine group are hydrophilic and the acetyl group and the hydrophobic group are hydrophobic. Accordingly, the glycol chitosan derivative according to the present invention may be referred to as an amphiphilic polymer.

As such, in an aqueous solution, the glycol chitosan derivative having a hydrophobic substituent according to the present invention, due to its hydrophobic group, may form a self-aggregate with a hydrophobic block, through hydrophobic bonding between molecules or within a molecule, thereby forming a minute area. Further, a hydrophilic block may surround the circumference of the hydrophobic block, thereby allowing the hydrophilic group to be directly in contact with the aqueous solution and thereby dissolved in water. Accordingly, the glycol chitosan derivative having a hydrophobic substituent may have excellent solubility and may form a nano-size micelle in an aqueous solution.

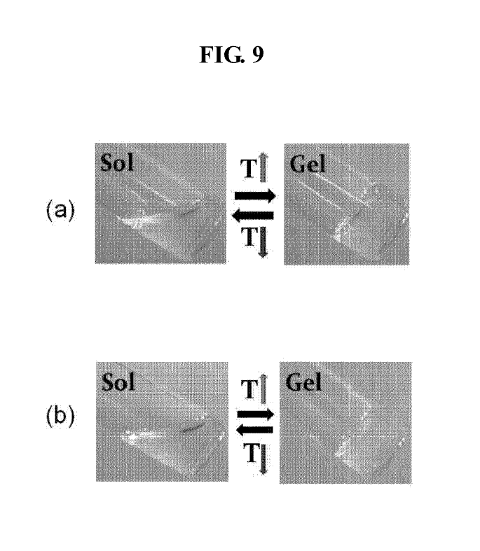

Meanwhile, the glycol chitosan derivative having a hydrophobic substituent according to the present invention may have a low critical solution temperature (LCST) in a range of about 15 to 70° C., and may have reversible sol-gel transition properties within the above-described range. Referring to FIGS. 9(a) and 9(b), the glycol chitosan derivative may have a sol state at room temperature, but may be converted into a gel when being applied with heat, and then may be converted back into a sol state when the temperature decreases.

Such reversible sol-gel transition properties of the derivative may allow phase transition from sol to gel and again from gel to sol according to temperature, thereby expanding its range of applications. In this case, a sol-gel critical temperature for causing the sol-gel transition may be controlled by a variety of parameters and may vary, desirably, according to a degree of substitution, types, and solubility of a substituent of the glycol chitosan.

In detail, as a degree of substitution of the hydrophobic group (acetyl group, R) increases, solubility may be reduced and the sol-gel critical temperature may decrease. Further, an increase in a degree of hydrophobation of the hydrophobic group R (e.i., an increase in types of the substituent or the number of alkyl groups (in the case of an alkyl group)) may lead to a tendency of change in the sol-gel critical temperature. In addition, when solution concentration is low, the sol-gel critical temperature may have a tendency to increase. In other words, in order to increase the sol-gel critical temperature, the degree of substitution of the hydrophobic group may be increased or the concentration may be reduced. In contrast, in order to decrease the sol-gel critical temperature, the type of the substituent or the number of alkyl groups may be changed. Since a linear relationship, when having the same composition, may appear between the sol-gel critical temperature and the degree of substitution, it is most advantageous to adjust the degree of substitution in order to control the sol-gel critical temperature.

Such sol-gel transition may take place in a certain range of the degree of substitution. A critical degree of substitution that may cause the sol-gel transition may be about 20 to 95% (corresponding to a value for z in Chemical Formula 1), and desirably about 20 to 70%. When being outside of the range, the revisable sol-gel transition may not occur. The critical degree of substitution may vary according to the type of substituents. Further, in the case of the N-acyl glycol chitosan prepared according to the present invention, sol-gel transition may occur with a degree of substitution in a range of about 20 to 67%.

In more detail, in the case of the N-propionyl glycol chitosan, the sol-gel transition may occur with a degree of substitution in a range of about 20 to 67%; in the case of N-butyryl glycol chitosan, about 20 to 55%; in the case of N-pentanoyl glycol chitosan, about 20 to 50%; and in the case of N-hexanoyl glycol chitosan, about 20 to 30%.

Further, the sol-gel critical temperature may vary according to the molecular weight of the glycol chitosan derivative having a hydrophobic substituent, and desirably, the derivative according to the present invention may be utilized with the molecular weight in a range of about 100 to 5,000,000, and more desirably about 200 to 100,000.

The glycol chitosan derivative having a hydrophobic substituent, as represented by the following Reaction Formula 1, may be prepared by reacting an N-acetylated glycol chitosan represented by Chemical Formula 6 with an RX compound represented by the following Chemical Formula 7,

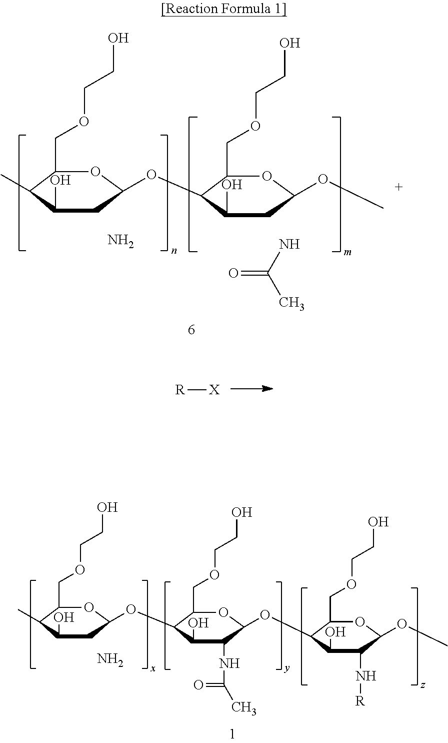

wherein R, x, y, and z may be identical to those of Chemical Formula 1, n and m each may be an integer selected from 10 to 10000, mole % thereof may be 0.8≦n≦0.975 and 0.025≦m≦0.2, and X may be a leaving group.

As a starting material, the N-acetylated glycol chitosan derivative may have an amine group at the 2-position partially N-acetylated. That can be self-prepared using methods known to those skilled in the art or may be available in the market. In the case of self-fabrication, an N-acetylated glycol chitosan derivative may be prepared by reacting a glycol chitosan with an acetylating agent. Further, the commercially available glycol chitosan may be provided by WAKO, SIGMA, or Tokyo Kasei. Acetic anhydride or acetic acid chloride (preferably, acetic anhydride) may be selectively used as the acetylating agent.

The R—X compound is a substance that can be substituted into —NH—R through a reaction with an amine (NH₂) of the N-acetylated glycol chitosan derivative. In this case, R is the above-described hydrophobic group and X is a leaving group.

It is desirable that X is: hydroxy-; a halogen element including Cl, F, and I; a C1-C4 alkoxy group; —C(═O)—OH; or —C(═O)—O—C(═O)—.

A mole ratio of the N-acetylated glycol chitosan derivative to the RX compound in the above reaction may be adjusted according to a desired degree of substitution of the hydrophobic group R in the resultant glycol chitosan. The mole ratio may be suitably adjusted in a range of, for example, about 0.1:10 to 10:0.1.

In this case, the reaction may be carried out at about −10 to 60° C., desirably at about 15 to 25° C., and for about 10 to 50 hours, desirably for about 40 to 50 hours. In addition, a reaction solvent, a catalyst, a reaction terminator, and the like, may be also used, if necessary. The available solvent may not be particularly limited in the present invention and may include one of water; low alcohol of methanol, ethanol, propanol, isopropanol, butanol, and etc.; dichloromethane, trichloromethane, tetrachloromethane, toluene, dimethylacetamide, N-methylpyrrolidone, dimethylsulfoxide, xylene, benzene, n-butyl acetate, methyl-cyclohexane, and dimethyl-cyclohexane, which may be used solely or in combination with another.

As illustrated in Reaction Formula 1, a hydrogen of the amine group at the 2-position may be substituted with an N-hydrophobic group by reacting a glycol chitosan with an R—X compound, and in this case, various types of the R—X compound may be used to incorporate various hydrophobic groups in the amine group at the 2-position.

For example, the glycol chitosan substituted with an acyl group represented by Chemical Formula 2 may be prepared by reacting an N-acetylated glycol chitosan represented by Chemical Formula 6 with an acylating agent represented by Chemical Formula 8, as illustrated in Reaction Formula 2.

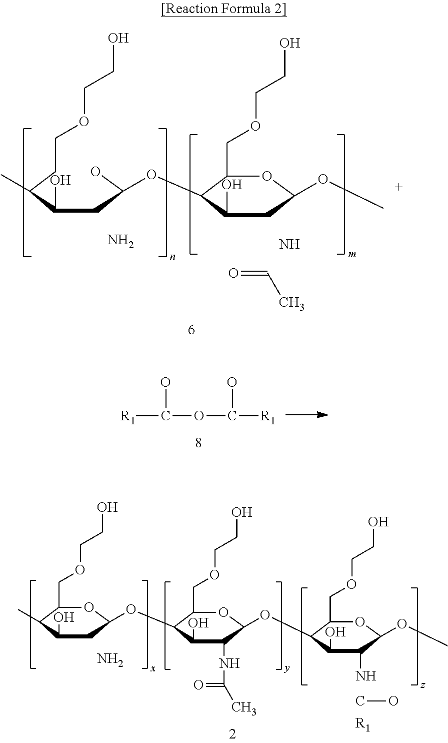

The reaction of Reaction Formula 2 may be carried out at room temperature without requiring a separate solvent. In this case, a degree of substitution of the acyl group (—C(═O)R₁) may be adjusted according to a mole ratio of the anhydride represented by Chemical Formula 8.

In detail, in the case of N-propionyl glycol chitosan having a propylacyl group as the hydrophobic group represented by Chemical Formula 3 may be prepared by reacting an N-acetylated glycol chitosan represented by Chemical Formula 6 with a propionic anhydride represented by Chemical Formula 9, as illustrated in Reaction Formula 3.

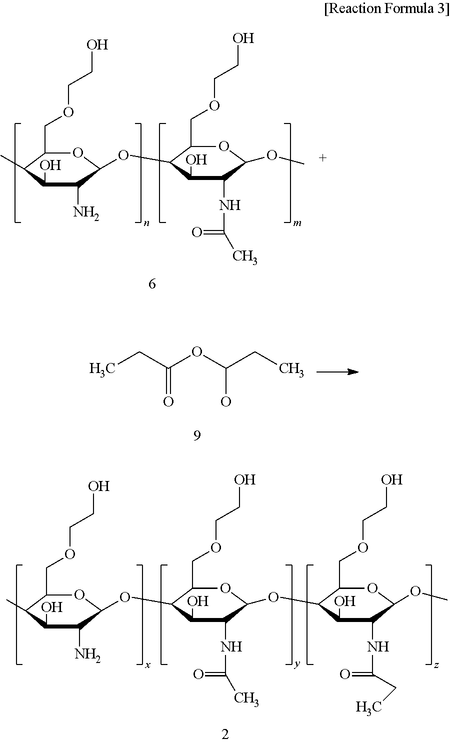

A glycol chitosan derivative having a hydrophobic substituent according to the present invention may be utilized in a wide range of applications in medical, bio, and electronics fields, by virtue of its thermo-sensitive properties at a predetermined temperature.

For example, the glycol chitosan according to the present invention may be applied to various fields, such as a medicament carrier for clathrating and delivering medicaments, a cell carrier for culturing, supporting, and delivering cells, a tissue engineering support, a gas storing member, a gas filter, a chemical reaction catalyst carrier, and a temperature-sensitive sensor.

In detail, considering most medicaments are hydrophobic and insoluable, the glycol chitosan derivative having a hydrophobic substituent according to the present invention may easily clathrate the hydrophobic and insoluable medicaments, due to its hydrophobic group in the derivative. In particular, in an aqueous solution, the glycol chitosan derivative according to the present invention may form a self-aggregate due to a hydrophobic block that includes a hydrophobic group and may form a micelle, thereby capable of clathrating a high content of hydrophobic and insoluble medicaments. Further, with the sol-gel transition properties, the glycol chitosan according to the present invention, after clathrating medicaments, may be converted into a gel state by temperature adjustment, and then converted back into a sol state by temperature adjustment to release the medicaments, thereby being effectively utilized as a medicament carrier.

In this case, the derivative according to the present invention may further include a hydrophilic group (an amine group, a glycol group) to facilitate clathration of hydrophilic medicaments.

Applicable hydrophilic, hydrophobic, and insoluble medicaments may not be particularly limited in the present invention, and thus any medicaments known to those skilled in the art may be utilized. For example, the hydrophilic medicament may include, for example, betamethasone phosphate, dexamethasone phosphate, prednisolone phosphate, succinic acid prednisolone, succinic acid hydrocortisone, vancomycin, vincristine, vinblastine, succinic acid chloramphenicol, latamoxef, cefpirome, carumonam, clindamycin phosphate, and abacavir. Further, the hydrophobic and insoluble medicaments may include, for example, testosterone enanthate, testosterone propionate, testosterone, estradiol, estradiol valerate, estradiol benzoate, dexamethasone acetate, betamethasone, betamethasone dipropionate, betamethasone valerate, prednisolone acetate, cyclosporin, tacrolimus, paclitaxel, irinotecan HCl, cisplatin, methotrexate, carmofur, tegafur, doxorubicin, clarithromycin, aztreonam, nalidixic acid, ofloxacin, norfloxacin, ketoprofen, flurbiprofen, flurbiprofen axetil, chloropromazine, diazepam, nifedipin, nicardipine HCl, amlodipine besylate, candesartan cilexetil, acyclovir, vidarabine, efavirenz, alprostadil, dinoprostone, ubidecarenone, vitamin A (retinol), vitamin D, vitamin E, and vitamin K.

Further, with the characteristics of adjustable thermo-reversible sol-gel transition in accordance with temperature along with its characteristics of biocompatibility and amphiphilicity, the glycol chitosan derivative having a hydrophobic substituent according to the present invention may be further utilized in a biotechnology field as a cell carrier.

That is, by virtue of its amphiphilic properties, the derivative according to the present invention may support cells having hydrophilic or hydrophobic properties. Further, when temperature is adjusted outside of the sol-gel critical temperature, the supported cells may become detachable due to the sol-gel transition of the derivative, thereby capable of being utilized as a cell carrier. Further, due to its hydrogel properties, the derivative according to the present invention may be utilized to culture various cells.

Applicable cells are not particularly limited in the present invention, and any cells, growth factors, peptides, and the like known to those skilled in the art may be applicable. For example, epithelial cells, fibroblasts, osteoblasts, chondrocytes, hepatocytes, human umbilical cord blood-derived mesenchymal stem cells, and human bone marrow-derived mesenchymal stem cells, preferably human bone marrow-derived mesenchymal stem cells, may be used. Further, the growth factors may include transforming growth factor-β (TGF), insulin-like growth factors (IGF), epidermal growth factors (EGF), nerve growth factors (NGF), vascular endothelial growth factors (VEGF), fibroblast growth factors (FGF), hepatocyte growth factor (HGF), platelet-derived growth factor (PDGF) and bone morphogenetic proteins (BMP).

Such glycol chitosan derivative having a hydrophobic substituent may be utilized in a semiconductor field as a sensor and the like, other than the above-described fields, by virtue of its thermo-sensitive characteristics. For example, the derivative may undergo sol-gel transition reversible according to temperature and may be thereby used as a temperature sensor or a detecting sensor for detecting objects.

Other than the above-described fields, the glycol chitosan derivative having a hydrophobic substituent according to the present invention may be applied to any fields where thermo-sensitive polymers or hydrogels are applicable.

### EXEMPLARY EMBODIMENTS

Hereinafter, desirable exemplary embodiments will be described. The following exemplary embodiments are illustrative only and are not intended to be in any way limiting.

### Exemplary Embodiment 1

### Preparation of N-Propionyl Glycol Chitosan

A polymer of the glycol chitosan derivative having a hydrophobic substituent is prepared according to the following Reaction Formula 3.

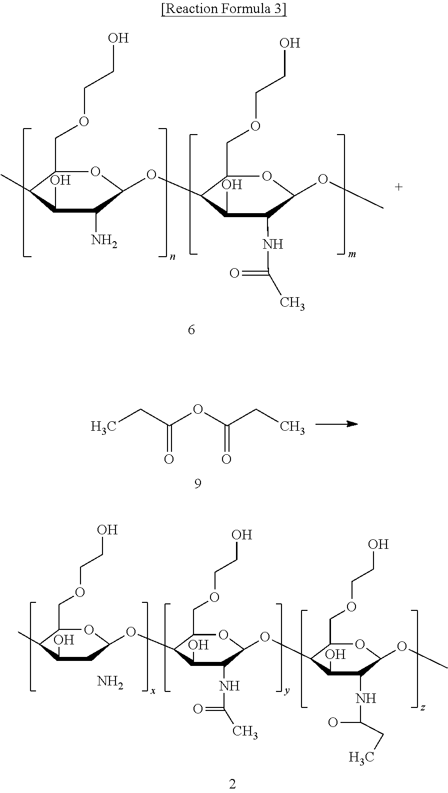

In a reactor, 10 g of acetylated glycol chitosan (weight average molecular weight of 400 kDa, degree of acetylation 9.34±2.50% (¹H-NMR measurement), Sigma-Aldrich, Inc., USA) is dissolved in 1000 ml of distilled water, and 1.95 g of propionic anhydride is then added thereto. The mixture is stirred for 48 hours at room temperature. In this case, a mole ratio of the glycol chitosan to the propionic anhydride is 1:0.6.

After the reaction is completed, cold acetone is added to obtain precipitate, and then a solid matter is obtained through centrifugation. Subsequently, the centrifuged solid is subject to dialyzation, for three days, with distilled water using a dialysis membrane having a molecular weight cut-off of 2 kDa, and then freeze-dried.

### Exemplary Embodiment 2

### Preparation of N-Propionyl Glycol Chitosan

A glycol chitosan derivative having a hydrophobic group is prepared in the same manner as in Exemplary Embodiment 1, except that the mole ratio of the acetylated glycol chitosan to the propionic anhydride is adjusted to 1:0.7.

### Exemplary Embodiment 3

### Preparation of N-Propionyl Glycol Chitosan

A glycol chitosan derivative having a hydrophobic group is prepared in the same manner as in Exemplary Embodiment 1, except that the mole ratio of the acetylated glycol chitosan to the propionic anhydride is adjusted to 1:0.8.

### Exemplary Embodiment 4

### Preparation of N-Propionyl Glycol Chitosan

A glycol chitosan derivative having a hydrophobic group is prepared in the same manner as in Exemplary Embodiment 1, except that the mole ratio of the acetylated glycol chitosan to the propionic anhydride is adjusted to 1:0.9.

### Exemplary Embodiment 5

### Preparation of N-Propionyl Glycol Chitosan

A glycol chitosan derivative having a hydrophobic group is prepared in the same manner as in Exemplary Embodiment 1, except that the mole ratio of the acetylated glycol chitosan to the propionic anhydride is adjusted to 1:1.

### Exemplary Embodiment 6

### Preparation of N-Butyryl Glycol Chitosan

As illustrated in Reaction Formula 4, a glycol chitosan derivative having a hydrophobic group is prepared in the same manner as in Exemplary Embodiment 1, except that 1.58 g of butyric anhydride is used instead of the propionic anhydride. In this case, the reaction is carried out with a mole ratio of 1:0.4 between the acetylated glycol chitosan and the butyric anhydride.

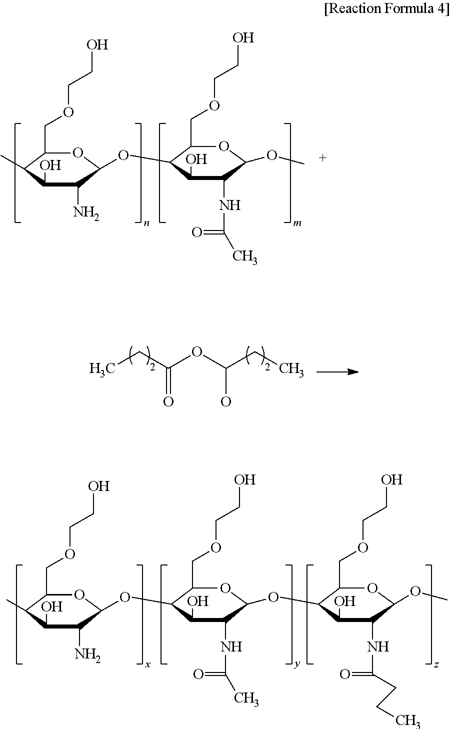

### Exemplary Embodiment 7

### Preparation of N-Butyryl Glycol Chitosan

A glycol chitosan derivative having a hydrophobic group is prepared in the same manner as in Exemplary Embodiment 6, except that the mole ratio of the acetylated glycol chitosan to the butyric anhydride is adjusted to 1:0.5.

### Exemplary Embodiment 8

### Preparation of N-Butyryl Glycol Chitosan

A glycol chitosan derivative having a hydrophobic group is prepared in the same manner as in Exemplary Embodiment 6, except that the mole ratio of the acetylated glycol chitosan to the butyric anhydride is adjusted to 1:0.6.

### Exemplary Embodiment 9

### Preparation of N-Butyryl Glycol Chitosan

A glycol chitosan derivative having a hydrophobic group is prepared in the same manner as in Exemplary Embodiment 6, except that the mole ratio of the acetylated glycol chitosan to the butyric anhydride is adjusted to 1:0.7.

### Exemplary Embodiment 10

### Preparation of N-Butyryl Glycol Chitosan

A glycol chitosan derivative having a hydrophobic group is prepared in the same manner as in Exemplary Embodiment 6, except that the mole ratio of the acetylated glycol chitosan to the butyric anhydride is adjusted to 1:0.8.

### Exemplary Embodiment 11

### Preparation of N-Pentanoyl Glycol Chitosan

As illustrated in the following Reaction Formula 5, a glycol chitosan derivative having a hydrophobic group is prepared in the same manner as in Exemplary Embodiment 1, except that 0.12 g of valeric anhydride is used instead of the propionic anhydride. In this case, the reaction is carried out with a mole ratio of 1:0.3 between the acetylated glycol chitosan and the valeric anhydride.

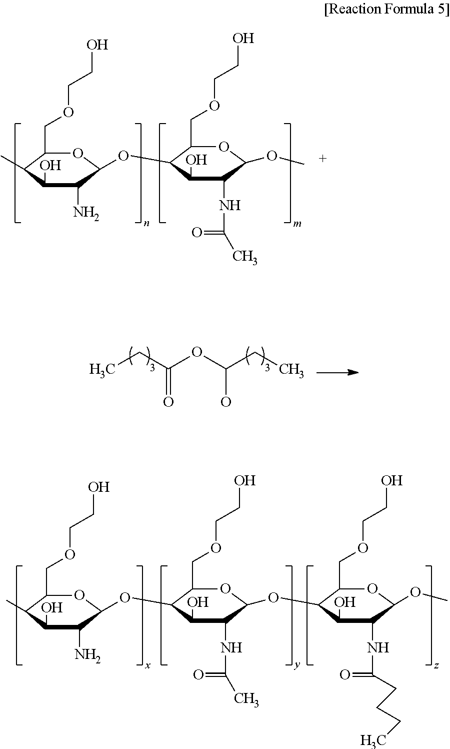

### Exemplary Embodiment 12

### Preparation of N-Pentanoyl Glycol Chitosan

A glycol chitosan derivative having a hydrophobic group is prepared in the same manner as in Exemplary Embodiment 11, except that the mole ratio of the acetylated glycol chitosan to the valeric anhydride is adjusted to 1:0.4.

### Exemplary Embodiment 13

### Preparation of N-Pentanoyl Glycol Chitosan

A glycol chitosan derivative having a hydrophobic group is prepared in the same manner as in Exemplary Embodiment 11, except that the mole ratio of the acetylated glycol chitosan to the valeric anhydride is adjusted to 1:0.5.

### Exemplary Embodiment 14

### Preparation of N-Pentanoyl Glycol Chitosan

A glycol chitosan derivative having a hydrophobic group is prepared in the same manner as in Exemplary Embodiment 11, except that the mole ratio of the acetylated glycol chitosan to the valeric anhydride is adjusted to 1:0.6.

### Exemplary Embodiment 15

### Preparation of N-Hexanoyl Glycol Chitosan

As illustrated in the following Reaction Formula 6, a glycol chitosan derivative having a hydrophobic group is prepared in the same manner as in Exemplary Embodiment 1, except that 1.07 g of hexanoic anhydride is used instead of the propionic anhydride. In this case, the reaction is carried out with a mole ratio of 1:0.2 between the acetylated glycol chitosan and the hexanoic anhydride.

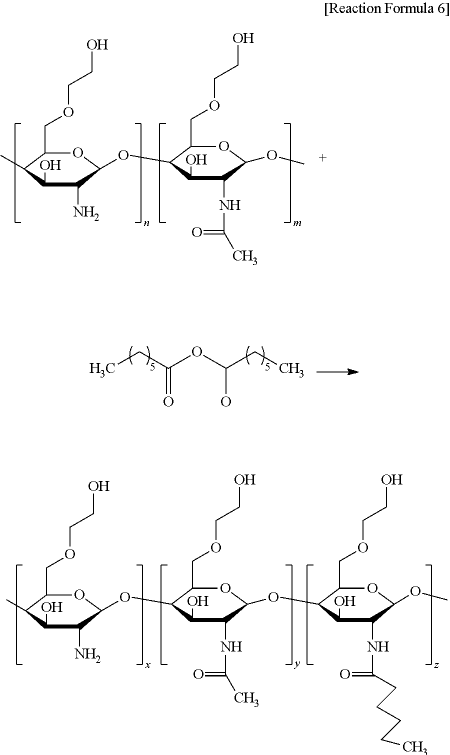

### Exemplary Embodiment 16

### Preparation of N-Hexanoyl Glycol Chitosan

A glycol chitosan derivative having a hydrophobic group is prepared in the same manner as in Exemplary Embodiment 15, except that the mole ratio of the acetylated glycol chitosan to the hexanoic anhydride is adjusted to 1:0.3.

### Exemplary Embodiment 17

### Preparation of N-Hexanoyl Glycol Chitosan

A glycol chitosan derivative having a hydrophobic group is prepared in the same manner as in Exemplary Embodiment 15, except that the mole ratio of the acetylated glycol chitosan to the hexanoic anhydride is adjusted to 1:0.4.

### Exemplary Embodiment 18

### Preparation of N-Hexanoyl Glycol Chitosan

A glycol chitosan derivative having a hydrophobic group is prepared in the same manner as in Exemplary Embodiment 15, except that the mole ratio of the acetylated glycol chitosan to the hexanoic anhydride is adjusted to 1:0.5.

### Experimental Example 1

### Analysis of Degree of Substitution and Yield Rate

Table 1 shows measurement of a degree of substitution and a yield rate of the glycol chitosan prepared according to Exemplary Embodiments 1 to 18. In this case, a glycol chitosan, which is a starting material, is used as Contrasting Example.

TABLE 1

| | Degree of | Yield |
|---|---|---|
| Category | substitution (%) | Rate (%) |
| Contrasting | 9.3 ± 2.5 | — |
| Example | | |
| Exemplary | 48.3 ± 1.6 | 80.2 |
| Embodiment 1 | | |
| Exemplary | 57.4 ± 2.1 | 78.7 |
| Embodiment 2 | | |
| Exemplary | 66.6 ± 2.2 | 76.8 |
| Embodiment 3 | | |
| Exemplary | 74.5 ± 1.9 | 82.2 |
| Embodiment 4 | | |
| Exemplary | 87.4 ± 1.5 | 81.7 |
| Embodiment 5 | | |
| Exemplary | 36.3 ± 1.1 | 80.7 |
| Embodiment 6 | | |
| Exemplary | 47.5 ± 1.8 | 79.5 |
| Embodiment 7 | | |
| Exemplary | 55.2 ± 2.1 | 77.3 |
| Embodiment 8 | | |
| Exemplary | 61.4 ± 1.8 | 81.6 |
| Embodiment 9 | | |
| — | — | — |
| Exemplary | 75.9 ± 2.8 | 82.9 |
| Embodiment 10 | | |
| Exemplary | 26.7 ± 1.9 | 77.6 |
| Embodiment 11 | | |
| Exemplary | 36.7 ± 2.1 | 75.5 |
| Embodiment 12 | | |
| Exemplary | 50.0 ± 1.8 | 79.3 |
| Embodiment 13 | | |
| Exemplary | 68.1 ± 1.2 | 80.5 |
| Embodiment 14 | | |
| Exemplary | 19.0 ± 1.6 | 76.4 |
| Embodiment 15 | | |
| Exemplary | 28.2 ± 2.0 | 78.8 |
| Embodiment 16 | | |
| Exemplary | 36.5 ± 2.0 | 82.3 |
| Embodiment 17 | | |
| Exemplary | 54.2 ± 1.9 | 75.8 |
| Embodiment 18 | | |

### Experimental Example 2

### ¹H-NMR Analysis

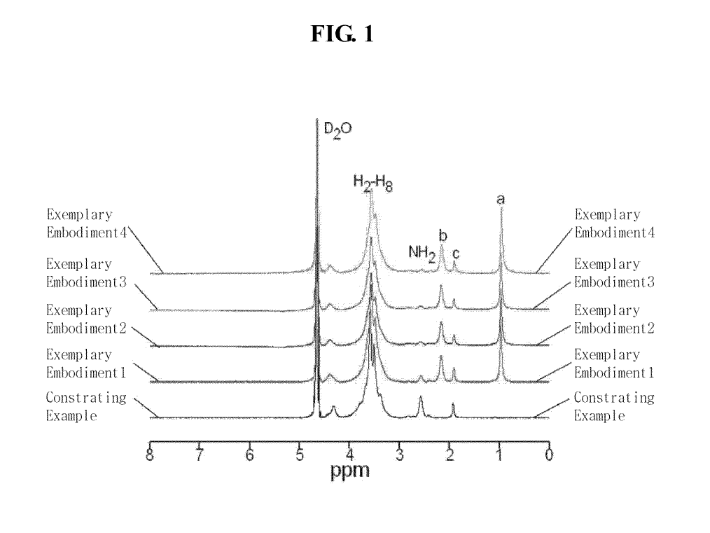

A ¹H-NMR analysis is carried out in order to identify composition of the —NH-alkylacyl glycol chitosan prepared according to Exemplary embodiments 1 to 18, and the results are shown in FIGS. 1 to 4.

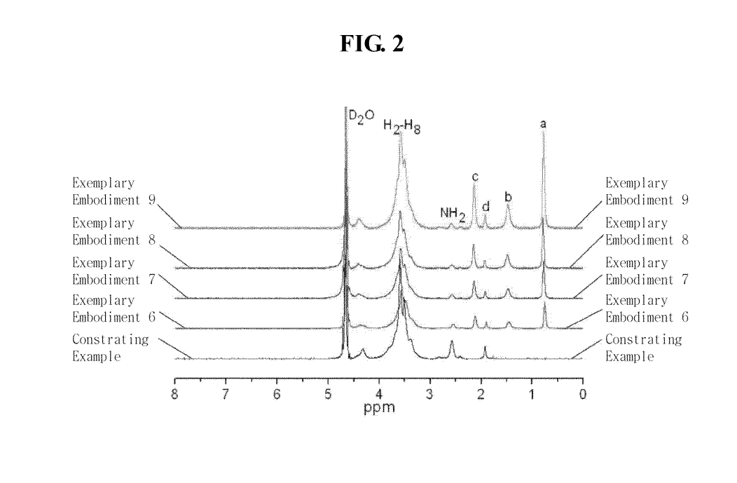

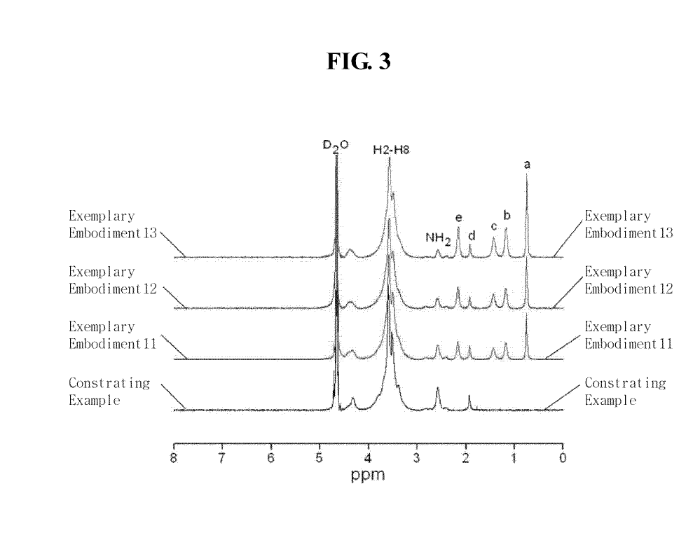

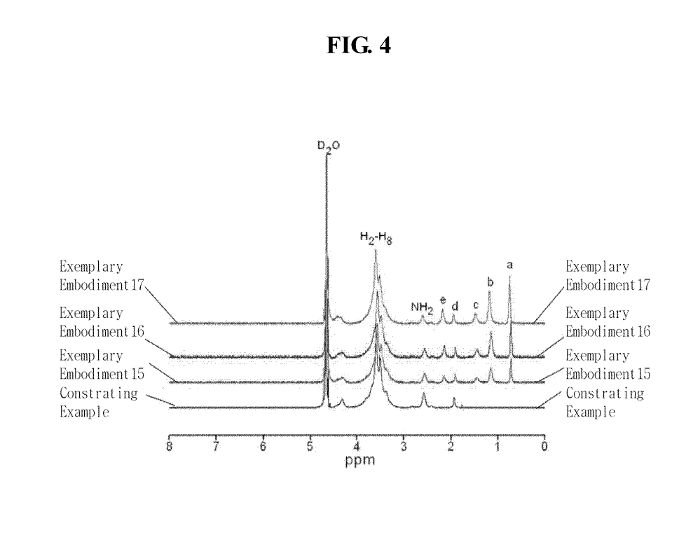

FIG. 1 is a ¹H-NMR spectrum of propionyl glycol chitosans prepared according to Exemplary Embodiments 1 to 5; FIG. 2 is a ¹H-NMR spectrum of butyryl glycol chitosans prepared according to Exemplary Embodiments 6 to 10; FIG. 3 is a ¹H-NMR spectrum of pentanoyl glycol chitosans prepared according to Exemplary Embodiments 11 to 14; and FIG. 4 is a ¹H-NMR spectrum of hexanoyl glycol chitosans prepared according to Exemplary Embodiments 15 to 18. Referring to FIGS. 1 to 4, it is identified that each reaction is desirably carried out.

### Experimental Example 3

### FT-IR Analysis

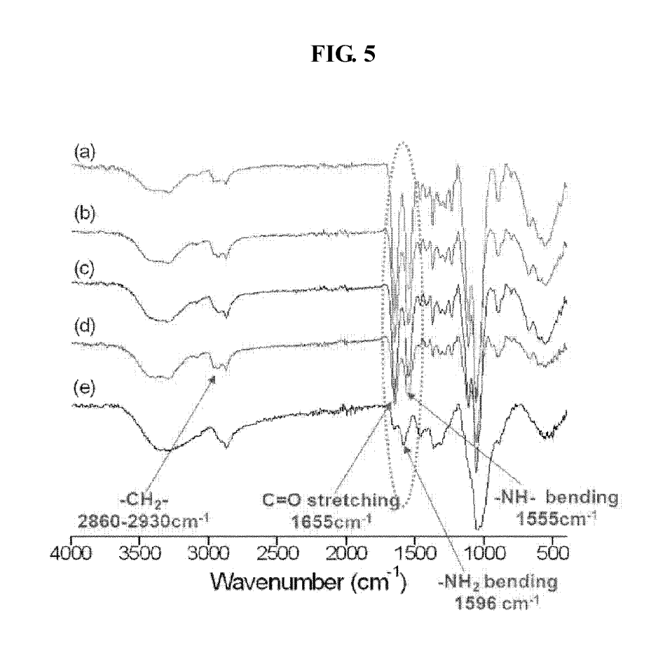

An FT-IR analysis is carried out in order to identify composition of the —NH-alkylacyl glycol chitosan according to Exemplary embodiments 1 to 18, and the results are shown in FIGS. 5 to 8.

FIG. 5 is a FT-IR spectrum of propionyl glycol chitosans prepared according to Exemplary Embodiments 1 to 4. In this case, a spectrum (a) illustrates a glycol chitosan according to Exemplary Embodiment 4; a spectrum (b) according to Exemplary Embodiment 3; a spectrum (c) according to Exemplary Embodiment 2; a spectrum (d) according to Exemplary Embodiment 1, and a spectrum (e) according to Contrasting Example. Referring to FIG. 5, the spectrums (a) to (d) show peaks at —CH₂—: 2860-2930 cm⁻¹, C═O: 1655 cm⁻¹, —NH₂: 1596 cm⁻¹, and —NH—: 1555 cm⁻¹, which does not appear on the spectrum (e) of the glycol chitosan according to Contrasting Example (e.i., a starting material), thereby showing that the propionyl reaction is carried out.

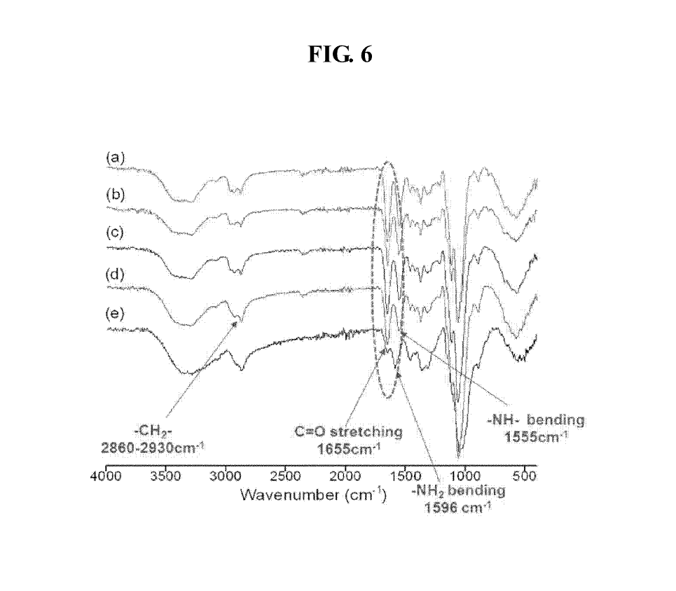

FIG. 6 is a FT-IR spectrum of butyryl glycol chitosans prepared according to Exemplary Embodiments 6 to 9. In this case, a spectrum (a) illustrates a glycol chitosan according to Exemplary Embodiment 9; a spectrum (b) according to Exemplary Embodiment 8; a spectrum (c) according to Exemplary Embodiment 7; a spectrum (d) according to Exemplary Embodiment 6; and a spectrum (e) according to Contrasting Example. Referring to FIG. 6, the spectrums (a) to (d) show peaks at —CH₂—: 2860-2930 cm⁻¹, C═O: 1655 cm⁻¹, —NH₂: 1596 cm⁻¹, —NH—: 1555 cm⁻¹, which does not appear on the spectrum (e) of the glycol chitosan according to Contrasting Example (e.i., a starting material), thereby showing that the butyryl reaction is carried out.

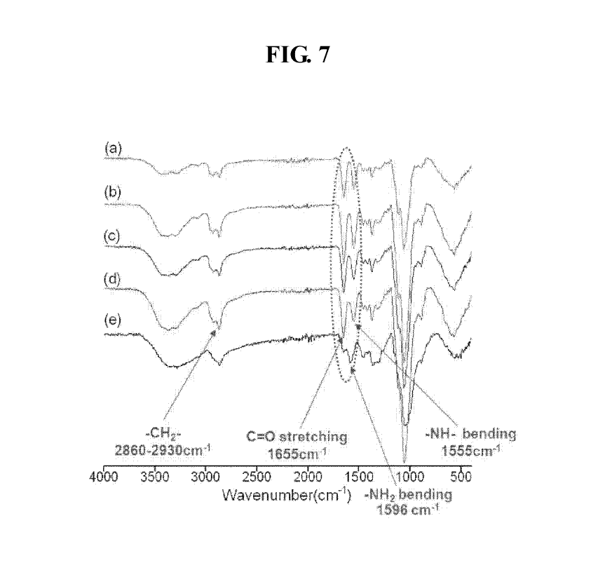

FIG. 7 is a FT-IR spectrum of pentanoyl glycol chitosans prepared according to Exemplary Embodiments 11 to 14. In this case, a spectrum (a) illustrates a glycol chitosan according to Exemplary Embodiment 14; a spectrum (b) according to Exemplary Embodiment 13; a spectrum (c) according to Exemplary Embodiment 12; a spectrum (d) according to Exemplary Embodiment 11; and a spectrum (e) according to Contrasting Example. Referring to FIG. 7, the spectrums (a) to (d) show peaks at —CH₂—: 2860-2930 cm⁻¹, C═O: 1655 cm¹, —NH₂: 1596 cm¹, —NH—: 1555 cm⁻¹, which does not appear on the spectrum (e) of the glycol chitosan according to Contrasting Example (e.i., a starting material), thereby showing that the pentanoyl reaction is carried out.

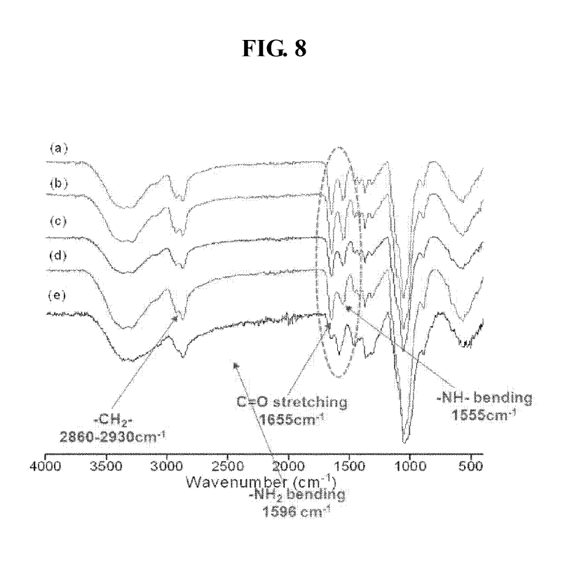

FIG. 8 is a FT-IR spectrum of hexanoyl glycol chitosans prepared according to Exemplary Embodiments 15 to 18. In this case, a spectrum (a) illustrates a glycol chitosan according to Exemplary Embodiment 18; a spectrum (b) according to Exemplary Embodiment 17; a spectrum (c) according to Exemplary Embodiment 16; a spectrum (d) according to Exemplary Embodiment 15; and a spectrum (e) according to Contrasting Example. Referring to FIG. 8, the spectrums (a) to (d) show peaks at —CH₂—: 2860-2930 cm⁻¹, C═O: 1655 cm¹, —NH₂: 1596 cm¹, —NH—: 1555 cm⁻¹, which does not appear on the spectrum (e) of the glycol chitosan according to Contrasting Example (e.i., a starting material), thereby showing that the hexanoyl reaction is carried out.

### Experimental Example 4

### Analysis on Sol-Gel Transition Properties

The —NH-alkylacyl glycol chitosans prepared according to Exemplary Embodiments 3 to 17 each are diluted into 5 wt %, and sol-gel behavior is observed.

FIG. 9(a) is a picture illustrating sol-gel behavior of the —NH-alkylacyl glycol chitosan prepared according to Exemplary Embodiment 3, and FIG. 9(b) is a picture illustrating sol-gel behavior of the —NH-alkylacyl glycol chitosan prepared according to Exemplary Embodiment 17. As illustrated in FIGS. 9(a) and 9(b), the —NH-alkylacyl glycol chitosan, when temperature is increased, is converted from a sol state to a gel state (Exemplary Embodiment 3: 55° C., Exemplary Embodiment 17: 29° C.), and then undergoes phase transition into a sol state when temperature is lowered. Such phase transition is reversibly carried out to expand a range of applications of the —NH-alkylacyl glycol chitosan derivative having a hydrophobic substituent according to the present invention.

### Experimental Example 5

### Analysis of Sol-Gel Critical Temperature According to Concentration

With the identified sol-gel phase transition properties, a sol-gel critical temperature according to the concentration of the —NH-alkylacyl glycol chitosan prepared according to Exemplary Embodiments is measured. In this case, in order to measure the sol-gel critical temperature, —NH-alkylacyl glycol chitosans are dissolved in water respectively into concentrations of 3, 4, 5, 6, and 7 wt %, and then heat is applied to measure a temperature at a time point when the —NH-alkylacyl glycol chitosan is transformed into a gel.

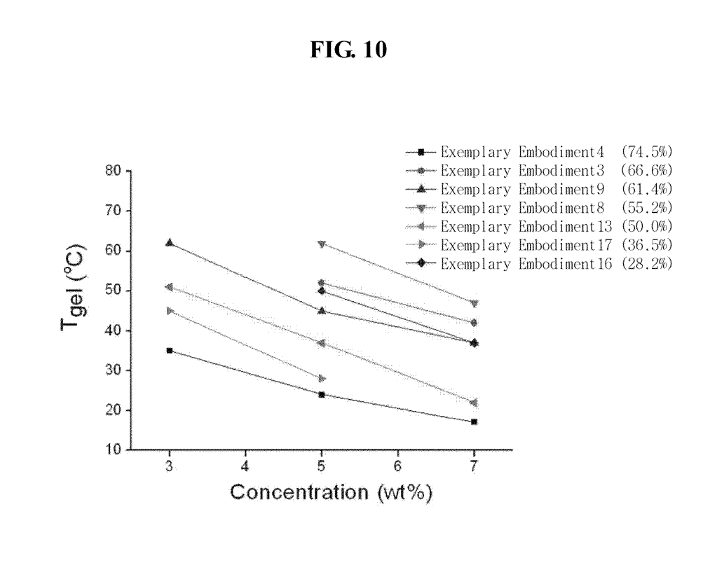

FIG. 10 is a graph showing a gel-conversion temperature of the —NH-alkylacyl glycol chitosans prepared according to Exemplary Embodiments 3, 4, 8, 9, 13, 16, and 17 in relation with the concentration thereof. Referring to FIG. 10, the sol-gel critical temperature, when provided with the same concentration of 3 wt %, changes according to the number of alkyl groups in an acyl group. In the case of the propionyl glycol chitosan according to Exemplary Embodiment 4 and the butyryl glycol chitosan according to Exemplary Embodiment 8, the sol-gel critical temperature increases in accordance with an increase in the number of alkyl groups. On the contrary, when comparing the butyryl glycol chitosan according to Exemplary Embodiment 4 and the hexylate glycol chitosan according to Exemplary Embodiment 17, the sol-gel critical temperature rather decreases when the number of alkyl groups in the acyl group is increased. In other words, the sol-gel critical temperature of the glycol chitosan derivative can be adjusted by adjusting the number of alkyl groups in the acyl group.

Further, in the case of the propionyl glycol chitosan according to Exemplary Embodiment 4, the sol-gel critical temperature has a tendency to decrease as the concentration increases. Such a tendency appears the same in other —NH-alkylacyl glycol chitosans.

Further, in the case of the butyryl glycol chitosans according to Exemplary Embodiments 8 and 9 having different degrees of substitution, when provided with a concentration of 7 wt %, the butyryl glycol chitosan according to Exemplary Embodiment 8 shows a tendency to have a higher sol-gel critical temperature. In other words, since the sol-gel critical temperature can be lowered when the —NH-alkylacyl glycol chitosan has a high degree of substitution, the sol-gel critical temperature can be adjusted according to a degree of substitution of the alkylacyl group.

### Experimental Example 6

### Analysis on Composition Change According to Temperature Change

With the result from Experimental Example 5, in order to identify whether or not chemical changes occur according to temperature, in the —NH-alkylacyl glycol chitosans according to the present invention, the —NH-alkylacyl glycol chitosans each are prepared into a concentration of 3 wt % with temperature changed into 20° C., 30° C., 40° C., 50° C., 60° C. and 70° C., and then ¹H-NMR analysis is carried out.

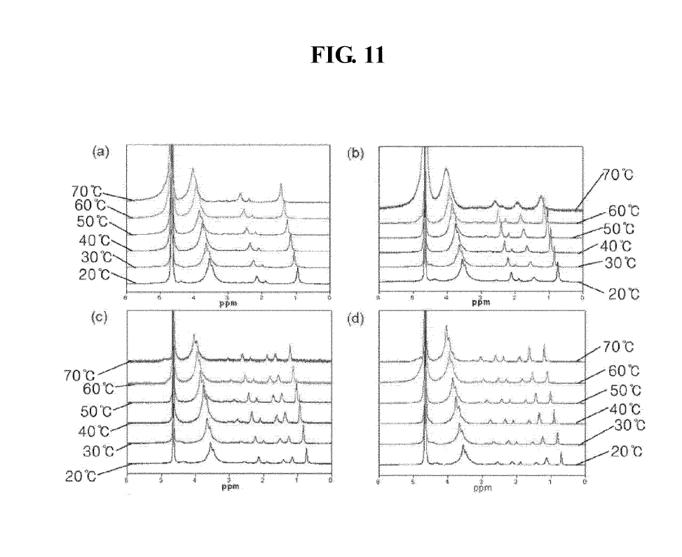

FIG. 11 is a ¹H-NMR spectrum of the —NH-alkylacyl glycol chitosan according to temperature, a spectrum (a) illustrates the —NH-alkylacyl glycol chitosan according to Exemplary Embodiment 4; a spectrum (b) according to Exemplary Embodiment 9; a spectrum (c) according to Exemplary Embodiment 13; and a spectrum (d) according to Exemplary Embodiment 17. Referring to FIG. 11, although temperature increases, the composition of the —NH-alkylacyl glycol chitosans does not change. In other words, the sol-gel transition occurs without any composition changes (e.g., cross-linking).

### Experimental Example 7

### Analysis of Critical Degree of Substitution for Sol-Gel Transition

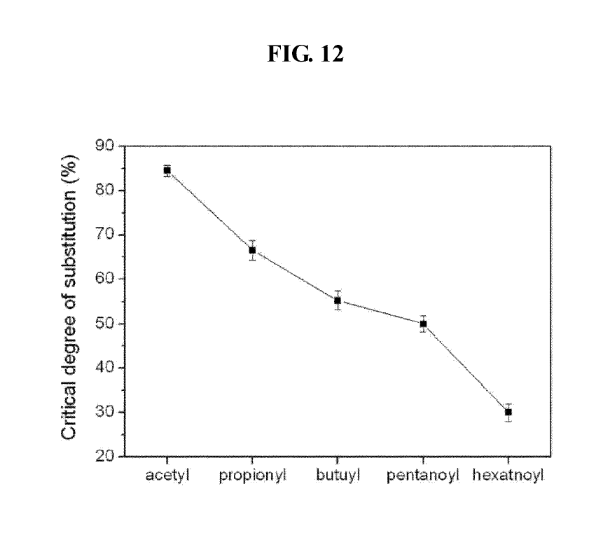

A critical degree of substitution is measured at which sol-gel transition of the −NH-alkylacyl glycol chitosan according to the present invention may occur, and the results are shown in FIG. 12.

FIG. 12 is a graph showing a critical degree of substitution of the —NH-alkylacyl glycol chitosan according to types of functional groups. Referring to FIG. 12, a glycol chitosan according to Contrasting Example (acetyl) shows a critical degree of substitution of about 84%, propionyl of an acyl group shows about 67%, a butyryl group shows about 55%, pentanoyl shows about 50%, and hexanoyl shows about 30%.

The glycol chitosan derivative having a hydrophobic substituent according to the present invention, by virtue of its amphiphilicity and biocompatibility as well as its thermo-sensitive characteristics of causing sol-gel transition at a predetermined temperature, may allow a wide range of applications in medical, bio, electric and other fields,

In particular, the temperature for causing the sol-gel transition can be adjusted according to types and degree of substitution of the hydrophobic substituent, thereby expanding its range of applications.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings. Various features of the above described and other embodiments can be mixed and matched in any manner, to produce further embodiments consistent with the invention.

What is claimed is:

1. A glycol chitosan derivative having a hydrophobic substituent represented by the following Chemical Formula 1, wherein an amine group at the 2-position is partially substituted with an acetyl group and a hydrophobic group R, the glycol chitosan having thermo-reversible sol-gel transition properties, 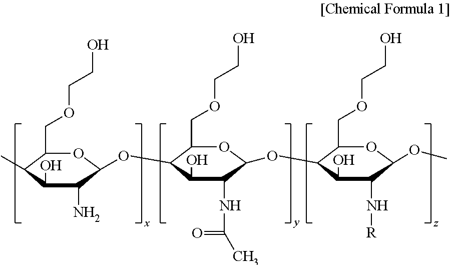
wherein R (hydrophobic group) is one of a cyano group, a nitro group, a C1-C18 alkyl group, a C1-C18 haloalkyl group, a C3-C8 cycloalkyl group, a C1-C20 acyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,
desirably, the acyl group is represented by —C(═O)—R₁ and R₁ is one of a C1-C18 alkyl group, a C1-C18 haloalkyl group, a C3-C8 cycloalkyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group, and
x, y, and z each are an integer selected from 10 to 10000 and mole % thereof are 0.1≦x≦0.6, 0.1≦y≦0.2, and 0.2≦z≦0.8, respectively.

2. The glycol chitosan derivative of claim 1, wherein a degree of substitution of the hydrophobic substituent of the glycol chitosan derivative having a hydrophobic substituent is in a range of about 20 to 95%.

3. The glycol chitosan derivative having a hydrophobic substituent of claim 1, which is represented by the following Chemical Formula 2, 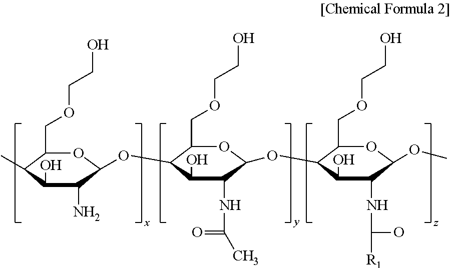
wherein x, y, and z are identical to those of Chemical Formula 1, and
R₁ is a C1-C18 alkyl group.

4. The glycol chitosan derivative having a hydrophobic substituent of claim 3, the hydrophobic substituent of the glycol chitosan derivative represented by Chemical Formula 2 has a degree of substitution in a range of about 20 to 70%.

5. The glycol chitosan derivative having a hydrophobic substituent of claim 1, comprising one of the following compounds:
(i) N-propionyl glycol chitosan;
(ii) N-butyryl glycol chitosan;
(iii) N-pentanoyl glycol chitosan; and
(iv) N-hexanoyl glycol chitosan.

6. The glycol chitosan derivative having a hydrophobic substituent of claim 5, wherein a degree of substitution of the hydrophobic substituent is in a range of about 20 to 67% when the glycol chitosan derivative having a hydrophobic substituent is an N-propionyl glycol chitosan; about 20 to 55% when an N-butyryl glycol chitosan; about 20 to 50% when an N-pentanoyl glycol chitosan; and about 20 to 30% when an N-hexanoyl glycol chitosan.

7. The glycol chitosan derivative having a hydrophobic substituent of claim 1, wherein the glycol chitosan derivative has a weight average molecular weight of about 200 to 5,000,000.

8. The glycol chitosan derivative having a hydrophobic substituent of claim 1, wherein the glycol chitosan derivative having a hydrophobic substituent has a low critical solution temperature (LCST) of about 15 to 70° C.

9. A method for preparing a glycol chitosan derivative having a hydrophobic substituent represented by Chemical Formula 1, comprising reacting an N-acetylated glycol chitosan derivative represented by Chemical Formula 6 with an RX derivative represented by Chemical Formula 7, the reaction represented by the following Reaction Formula 1, 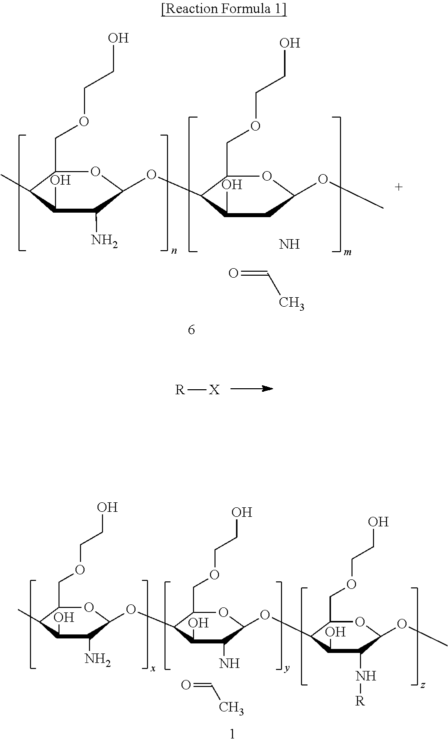
wherein R (hydrophobic group) is one of a cyano group, a nitro group, a C1-C18 alkyl group, a C1-C18 haloalkyl group, a C3-C8 cycloalkyl group, a C1-C20 acyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,
the acyl group is represented by —C(═O)—R₁ and R₁ is one of a C1-C18 alkyl group, a C1-C18 haloalkyl group, a C3-C8 cycloalkyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,
x, y, and z each are an integer selected from 10 to 10000 and mole % thereof are 0.1≦x≦0.6, 0.1≦y≦0.2, and 0.2≦z≦0.8, respectively.
n and m each are an integer selected from 10 to 10000 and mole % thereof are 0.8≦n≦0.975 and 0.025≦m≦0.2, and
X is a leaving group.

10. The method of claim 9, wherein X is hydroxy-; a halogen element comprising Cl, F, and I; a C1-C4 alkoxy group; —C(═O)—OH; or —C(═O)—O—C(═O)—.

11. A method for preparing a glycol chitosan derivative having a hydrophobic substituent represented by Chemical Formula 2, comprising reacting an N-acetylated glycol chitosan derivative represented by Chemical Formula 6 with an acylating agent represented by Chemical Formula 8, the reaction represented by the following Reaction Formula 2, 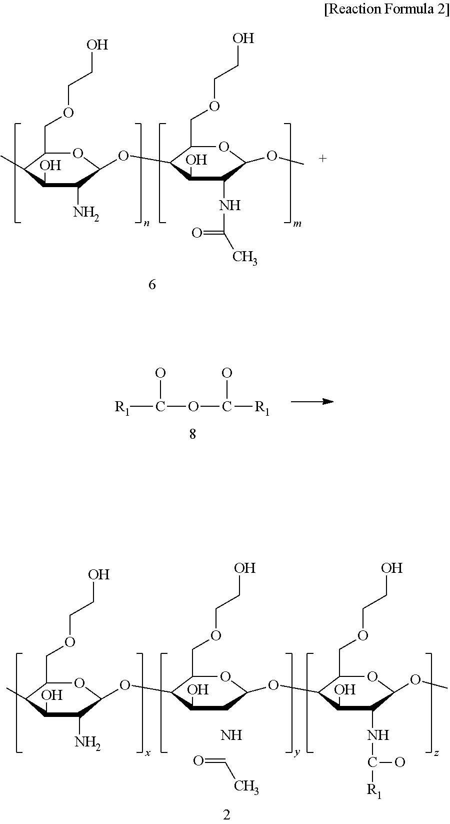
wherein x, y, and z are identical to those of Chemical Formula 1, and
R₁ is a C1-C18 alkyl group.

12. A medicament carrier comprising a glycol chitosan derivative having a hydrophobic substituent represented by the following Chemical Formula 1 or comprising a pharmaceutically acceptable salt thereof, the medicament carrier clathrating and then releasing medicament, 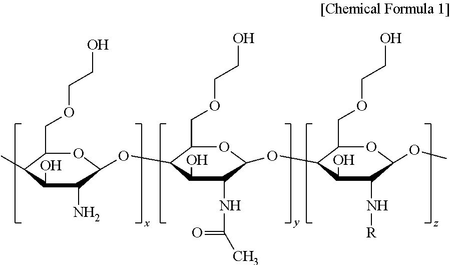
wherein R (hydrophobic group) is one of a cyano group, a nitro group, a C1-C18 alkyl group, a C1-C18 haloalkyl group, a C3-C8 cycloalkyl group, a C1-C20 acyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,
the acyl group is represented by —C(═O)—R₁ and R₁ is one of a C1-C18 alkyl group, a C1-C18 haloalkyl group, a C3-C8 cycloalkyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group, and
x, y, and z each are an integer selected from 10 to 10000 and mole % thereof are 0.1≦x≦0.6, 0.1≦y≦0.2, and 0.2≦z≦0.8, respectively.

13. A cell carrier comprising a glycol chitosan derivative having a hydrophobic substituent represented by the following Chemical Formula 1 or comprising a pharmaceutically acceptable salt thereof, the cell carrier supporting or delivering cells, 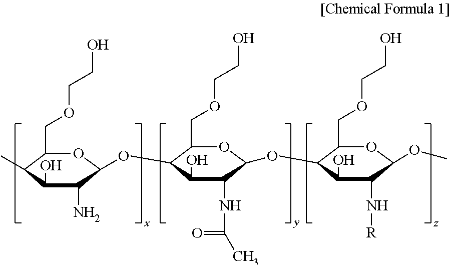
wherein R (hydrophobic group) is one of a cyano group, a nitro group, a C1-C18 alkyl group, a C1-C18 haloalkyl group, a C3-C8 cycloalkyl group, a C1-C20 acyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,
the acyl group is represented by —C(═O)—R₁ and R₁ is one of a C1-C18 alkyl group, a C1-C18 haloalkyl group, a C3-C8 cycloalkyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group, and
x, y, and z each are an integer selected from 10 to 10000 and mole % thereof are 0.1≦x≦0.6, 0.1≦y≦0.2, and 0.2≦z≦0.8, respectively.

14. A thermo-sensitive sensor, comprising a glycol chitosan derivative having a hydrophobic substituent represented by the following Chemical Formula 1, 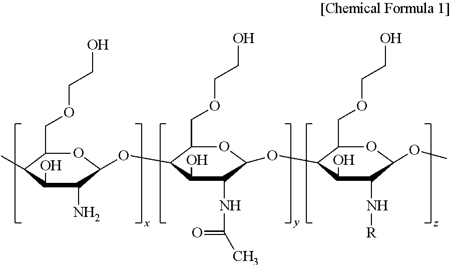
wherein R (hydrophobic group) is one of a cyano group, a nitro group, a C1-C18 alkyl group, a C1-C18 haloalkyl group, a C3-C8 cycloalkyl group, a C1-C20 acyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group,
the acyl group is represented by —C(═O)—R₁ and R₁ is one of a C1-C18 alkyl group, a C1-C18 haloalkyl group, a C3-C8 cycloalkyl group, a C1-C8 alkoxy group, a C1-C8 alkylcarbonyl group, a C1-C8 alkoxycarbonyl group, a C6-C14 aryl group, a C6-C10 arylalkyl group, and a C6-C10 arylcarbonyl group, and
x, y, and z each are an integer selected from 10 to 10000 and mole % thereof are 0.1≦x≦0.6, 0.1≦y≦0.2, and 0.2≦z≦0.8, respectively.
